(19) United States
(12) Patent Application Publication
(10) Pub. No.: US 2019/0242359 A1
(43) Pub. Date: Aug. 8, 2019

(54) WIND-TUNNEL TURBINE VACUUM AIR FLOW GENERATOR

(71) Applicant: John Oscar RIDER, Vacaville, CA (US)

(72) Inventor: John Oscar RIDER, Vacaville, CA (US)

(21) Appl. No.: 16/218,445

(22) Filed: Dec. 12, 2018

Related U.S. Application Data
(60) Provisional application No. 62/597,573, filed on Dec. 12, 2017.
(60) Provisional application No. 62/598,758, filed on Dec. 14, 2017.

(51) Int. Cl. F03D 1/02; F03D 1/04; F03D 9/25; F04D 25/02

(52) U.S. Cl. CPC F03D 1/025; F03D 1/04; F03D 9/25; F05B 2270/20; F05B 2220/706; F05B 2220/60; F04D 25/024

(57) ABSTRACT

A wind turbine generator assembly comprising an enclosure forming an air pathway; one or more wind turbines within the enclosure air pathway for generating power from air flow through the air pathway; a powered induction fan located at the upstream end of the enclosure air pathway for directing and accelerating ambient air flow into the enclosure and along the air pathway; and a powered vacuum fan located within the air pathway downstream from at least one wind turbine, the vacuum fan operating to create a negative pressure downstream from the wind turbine to increase air flow across the wind turbine and increase the efficiency of power generation by the wind turbines. In some embodiments, the air pathway within the enclosure forms a straight path with no turns and has a substantially constant cross-section between the location of the induction fan and the vacuum fan.

The present application claims priority from U.S. Provisional Patent Application No. 62/597,573, filed Dec. 12, 2017, entitled “WIND-TUNNEL TURBINE GENERATOR” by John Oscar Rider, and from U.S. Provisional Patent Application No. 62/598,758, filed Dec. 14, 2017, entitled “WIND-TUNNEL TURBINE GENERATOR” by John Oscar Rider, both of which are incorporated by reference herein in their entirety.

### TECHNICAL FIELD OF THE INVENTION

The present invention relates generally to wind turbine generators, specifically wind turbine generators using powered fan acceleration of ambient air flow.

### BACKGROUND OF THE INVENTION

In present times, people are always looking for ways to produce energy from the wind. Conventional wind turbine systems need to be about 50 meters tall and located away from everything else like trees, barns, houses, power lines/poles and people so there is no danger from spinning fans and that the wind source is not disrupted. Conventional wind turbine systems yield a minimal amount of power with most only collecting about 32% of their max output.

Conventional wind turbine systems are also dangerous to wildlife. Conventional open bladed wind turbines kill thousands of hawks and eagles each year. Such systems are also dangerous to people and so cannot be mounted in areas accessible to workers or the public. Conventional wind turbine systems are also unsightly, which limits their use near homes or living spaces. For these reasons, most wind turbines in commercial use tend to be located in large wind turbine farms located far away from cities and neighborhood. This results in relatively large transmission-related energy losses when transmitting the generated electricity from the wind farms to the cities and homes where it is needed.

What is needed is an improved wind turbine generator assembly that overcomes the limitations of the prior art.

### SUMMARY OF THE INVENTION

According to embodiments of the present invention, a wind turbine generator assembly comprises: an enclosure forming an air pathway; one or more wind turbines within the enclosure air pathway for generating power from air flow through the air pathway; a powered induction fan located at the upstream end of the enclosure air pathway for directing and accelerating ambient air flow into the enclosure and along the air pathway; and a powered vacuum fan located within the air pathway downstream from at least one wind turbine, the vacuum fan operating to create a negative pressure downstream from the wind turbine to increase air flow across the wind turbine and increase the efficiency of power generation by the wind turbine. In some embodiments, the air pathway within the enclosure forms a straight path with no turns and has a substantially constant cross-section between the location of the induction fan and the vacuum fan.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1A is a diagram of a wind turbine generator assembly according to an embodiment of the present invention.

FIG. 1B shows an exemplary wind turbine that could be used in an embodiment.

FIG. 2 shows an exploded perspective view of an embodiment of the present invention.

FIG. 3 is a diagram showing electrical connections for an embodiment of the present invention.

FIG. 4A shows an exterior housing according to an embodiment of the present invention.

FIG. 4B shows an end view of an exterior housing according to an embodiment of the present invention.

FIG. 5 shows another embodiment of a wind turbine generator assembly according to an embodiment of the present invention.

The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION OF PREFERRED EMBODIMENTS

Embodiments of the present invention aim to solve problems that are associated with conventional wind turbine systems. Embodiments of the present invention provide a wind turbine generator assembly that is much more compact and also more reliable and efficient than conventional wind turbine systems. In embodiments of the invention, the wind turbines and electrical components are enclosed within a housing or “tunnel,” which both protects people and animals from the rotating fan blades and protects the electrical components of the assembly itself from the elements. In a particular embodiment, a wind-tunnel generator according to the present invention could power a single-family household with a single tunnel system. The assembly makes use of an induction fan to control and steer air flow through the turbine(s). The arrangement of induction fans and the tunnel design of such embodiments serve to direct atmospheric air flow directly into the center of one or more wind turbines that generate electricity. A second fan can be mounted at the back end of the assembly tunnel creating a vacuum effect of air flow through the tunnel to increase turbine efficiency.

Significantly, embodiments of the present invention can have a substantially smaller footprint than conventional systems, making them suitable for use to provide power to single-family homes, among other uses. Other embodiments can be scaled up or down (by modifying the number and size of tunnels, number and size of induction fans, and/or the number and size of wind turbines) depending upon environmental conditions and/or energy needs. Different embodiments of the present invention can be used, for example, to provide power for a single-family, off-grid home, or as a part of an electrical grid connected to multiple single-family homes, apartments, businesses, cities and towns. Other embodiments can be used to create wind farms inside towns, or to provide power to large warehouses and business that are close to residential areas so that conventional wind turbine systems are not feasible. In some embodiments, mobile wind-tunnel generators can be mounted to vehicles, such as busses or trains, or used in elevators or tunnels where there is suitable air flow.

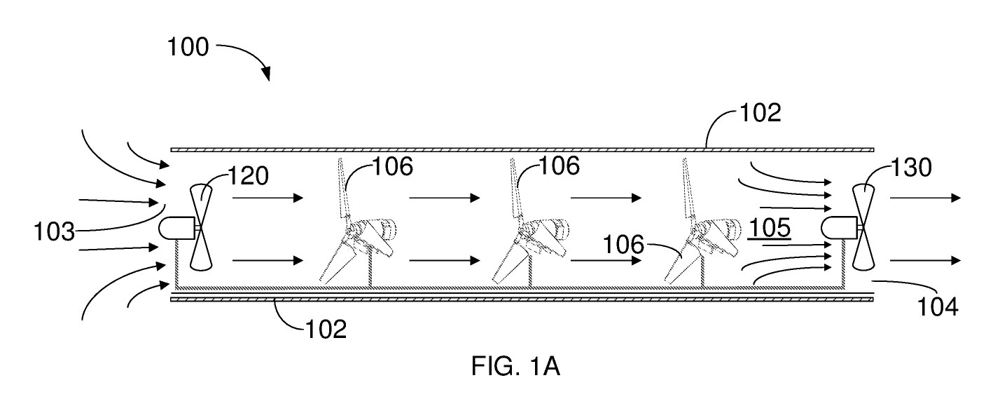

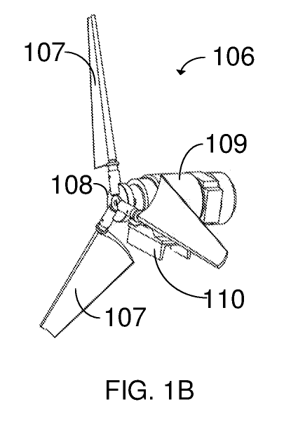

FIG. 1A shows a generator assembly 100 according to an embodiment of the invention. In the diagram of FIG. 1A, air flow is in the direction from left to right. The wind turbine generator assembly comprises a hollow enclosure 102 with an inlet opening 103 and an outlet opening 104 in fluid communication so that an air stream entering the enclosure through the inlet opening 103 will flow through the enclosure to the outlet opening 104. As used herein, the portion of the enclosure/air pathway closer to the inlet will be referred to as “upstream,” while a portion closer to the outlet will be referred to as “downstream.” In some embodiments, the air pathway formed by the enclosure is substantially straight with no curves or turns to generate turbulence or slow the air flow. In the embodiment of FIG. 1A, the enclosure 102 is generally cylindrical in shape with a substantially constant cross-section, although other shapes could be used. In some embodiments, for example, the interior shape of the walls of the enclosure could be varied to form known nozzle and/or diffuser shapes to accelerate wind speed and augment wind power. Enclosure 102 can be constructed from any suitable material such as sheet metal, cast metal, plastic or the like.

One or more wind turbines 106 are mounted within the air flow path through the enclosure. In some embodiments, the one or more wind turbines are conventional horizontal-axis wind turbines mounted to be coaxial with the longitudinal axis of the air flow path. Referring also to FIG. 1B, when air flows along the air path and over the wind turbine(s), the energy in the air flow rotates the blades 107 of the wind turbine causing rotation of a shaft 108, which in turn spins a generator 109 to produce electricity. In other embodiments, especially embodiments in which the enclosure is mounted vertically as described below, other known types of wind turbines such as vertical-axis type wind turbines, could be used. Although the embodiment of FIG. 1A uses three turbines, different numbers and sizes of turbines can be used depending upon factors such as power generation requirements and environmental conditions.

As will be recognized by those skilled in the art, that the rotation of the shaft can be used to accomplish a variety of conventional functions from mechanical work to driving an electrical generator. Although much of the discussion herein is directed to the production of electrical power by way of a generator, in embodiments of the invention the rotational energy of the turbine could be translated into any desired conventional form of energy, whether mechanical or electrical, without limitation.

Induction fan 120 is mounted in or near the inlet opening 103 of the enclosure 102 to pull air into the air pathway formed by the enclosure and to accelerate the air flow toward the one or more wind turbines 106. In some embodiments, induction fan 120 is mounted so that its horizontal axis of rotation is coaxial with the longitudinal axis of the air flow path longitudinal axis of the air flow path. Induction fan 120 can be a conventional electric fan having one or more blades mounted onto a shaft rotated by a DC or AC electric motor that provides sufficient speed and torque to produce the desired air flow for operation of the wind turbines. By way of a non-limiting example, in some embodiments, the induction fan will rotate at a speed which will accelerate the existing ambient air flow by 2 to 20 mph, such as from 5 to 15 mph, or approximately 10 mph. In such an embodiment, air flow through the air pathway after acceleration by the induction fan, could be from 5 to 40 mph, such as from 15 to 30 mph, 18-28 mph, or approximately 25 mph, depending upon the existing air flow. In some embodiments, the induction fan is driven by a variable-speed electric motor so that the speed of the induction fan can be varied in response to changes in the velocity of the ambient air flow so as to provide a constant air velocity across the wind turbine(s). The induction fan also can be provided with variable-pitch blades, which can be controlled to achieve the same or a similar result with a fixed-speed motor.

While not intending to be bound by any theory, Applicant believes that the use of the induction fan serves to concentrate and accelerate a larger amount of flowing air through the enclosure than would otherwise be produced by wind alone. It is well known that the recoverable kinetic energy is proportional to the third power of the wind velocity or speed. Thus, doubling the air flow speed will increase the power recovered by eight times.

The induction fan 120 also serves to capture and redirect a larger amount of ambient air flow that is not aligned with the axis of the air pathway. The arrows in FIG. 1A illustrate the direction of air flow during operation of the motorized induction and vacuum fans. By collecting flowing air from an area much larger than the inlet opening, use of an induction fan according to embodiments of the invention is believed to propel this larger than normal volume of air over the wind turbines, thus increasing the energy from the air flow available for extraction by the wind turbine(s). Even though the operation of the induction fan consumes energy to operate the fan motor, the degree of increase in energy input from the increased air flow is believed to provide the overall net beneficial effect of the induction fan.

Vacuum fan 130 is mounted in or near the outlet opening 104 of the enclosure 102 to draw air out of the air pathway where it will be discharged to atmosphere. In some embodiments, vacuum fan 130 is a conventional electric fan having one or more blades mounted onto a shaft rotated by a DC or AC electric motor that provides sufficient speed and torque to produce the desired air flow. Operation of the vacuum fan will produce a negative pressure area in the portion 105 of the air pathway downstream from the wind turbine(s), which draws more air through the turbine(s) and which, in turn, increases the efficiency of energy capture by the turbine(s). By accelerating the air flow downstream from the wind turbine(s), embodiments of the invention make it possible to exceed the maximum wind turbine efficiency calculated using the “Betz” momentum theory, which relates to the deceleration of the air flow traversing a wind turbine.

The apparatus illustrated in FIG. 1A will now be described with respect to its mode of operation. In the embodiment of FIG. 1A, the wind turbine generator assembly can be positioned so that the inlet opening is permanently aligned with the prevailing wind. Such embodiments are especially suited for locations with a steady ambient airflow with a prevailing wind direction. Induction fan 120, which is mounted within the inlet opening 103, is operated to capture and redirect ambient air flow and accelerate it down air pathway 101.

In the embodiment of FIG. 1A, the air pathway 101 formed by the enclosure 102 is generally cylindrical in shape and has a substantially constant cross section, without any curves, turns, or restrictions. Conventional tunnel systems with curves and/or turns within the air channel generate turbulence within the air channel, which can lead to deterioration and premature breakdown of the wind turbines. Conventional tunnel systems with curves and/or turns may also cause inconsistent air flow within the air channel, creating intermittent power generations from the wind turbines housed within.

The air pathway 101 of FIG. 1A is also free from any restrictions or narrowing/expanding areas intended to create nozzles or diffusers to accelerate air flow speed. Applicant has discovered that the use of the induction and vacuum fans renders such features unnecessary or even harmful to efficient power generation. While many conventional wind turbine systems make use of narrowing air pathways (nozzles) to increase air velocity, such features actually reduce total air flow, which is undesirable for efficient wind turbine energy production. Because total air flow (both speed and mass flow) is being accelerated by the induction and vacuum fans, increased friction caused by air flow coming into contact with such restrictions or turns may actually reduce the available energy in the air flow. Any impediment to air flow (such as a restriction or curve in the air path) tends to increase turbulence in the air flow, which reduces the efficiency of energy extraction by the wind turbines. This is especially significant for embodiments intended for installation in locations such as building rooftops where there is already a high degree of turbulence in the ambient air flow. Enclosures having air pathways free from restrictions or narrowing/expanding areas also have the advantages of lower manufacturing costs and ease of installation/maintenance.

As the air flows through the air pathway 101, it flows over one or more wind turbines 106 mounted in the pathway. The air flow causes the rotation of the blades 107 and shaft of each of the wind turbines 108, which operates to turn some of the kinetic energy in the air flow into electricity by way of one or more generators 109. At the same time, vacuum fan 130 is operated to pull and accelerate the now-lower energy air flow downstream from the wind turbine(s) (in downstream air pathway 105) and cause this air flow to be discharged through the outlet opening. By pulling the lower energy air flow away from the downstream air pathway 105, a negative pressure area is created, which in turn pulls additional air flow past the wind turbine(s) thus greatly increasing the efficiency of the turbine operation beyond the Betz limit.

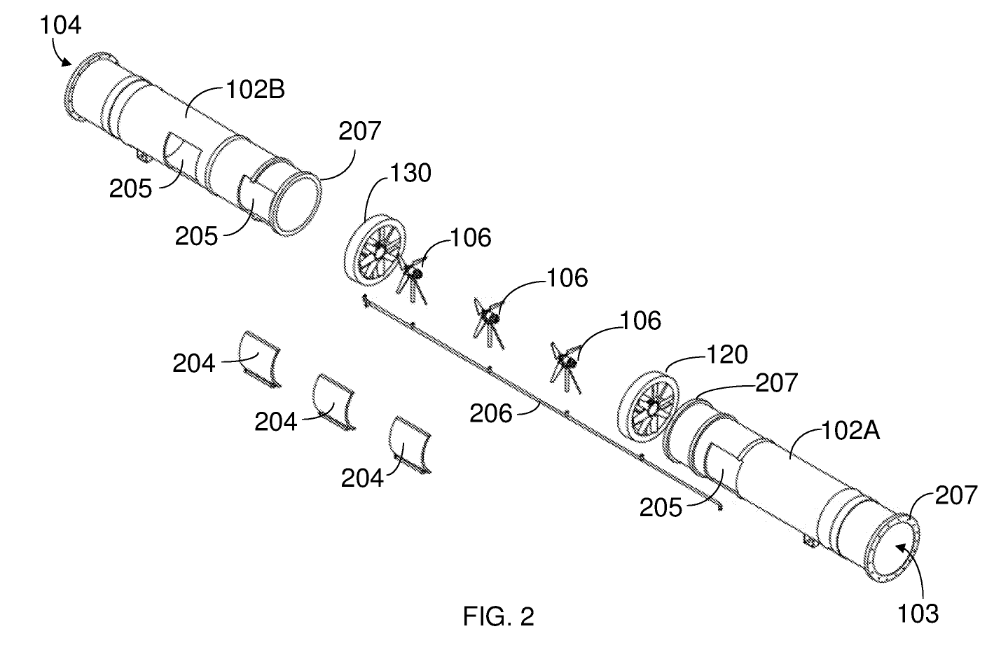

FIG. 2 shows an exploded perspective view of a generator assembly 200 according to an embodiment of the invention. In the embodiment of FIG. 2, the enclosure is formed from two separate enclosure sections (102A, 102B) that can be attached together by connection flanges 207 to form an air tight seal between the two sections. Within the assembled enclosure sections 102A, 102B, a lower mounting assembly 206 can serve to at least partially secure the fans 120, 130 and wind turbines 106 in place within the enclosure. In some embodiments, lower mounting assembly 206 can also include a conduit to contain and secure the wiring connecting the fans and turbines together and to the other electrical components of the assembly as described below. Enclosure access ports 205 can be used to access various components such as the wind turbines for repair or service. Enclosure access port doors 204 can be used to provide an air-tight seal for the access ports when the assembly is in operation.

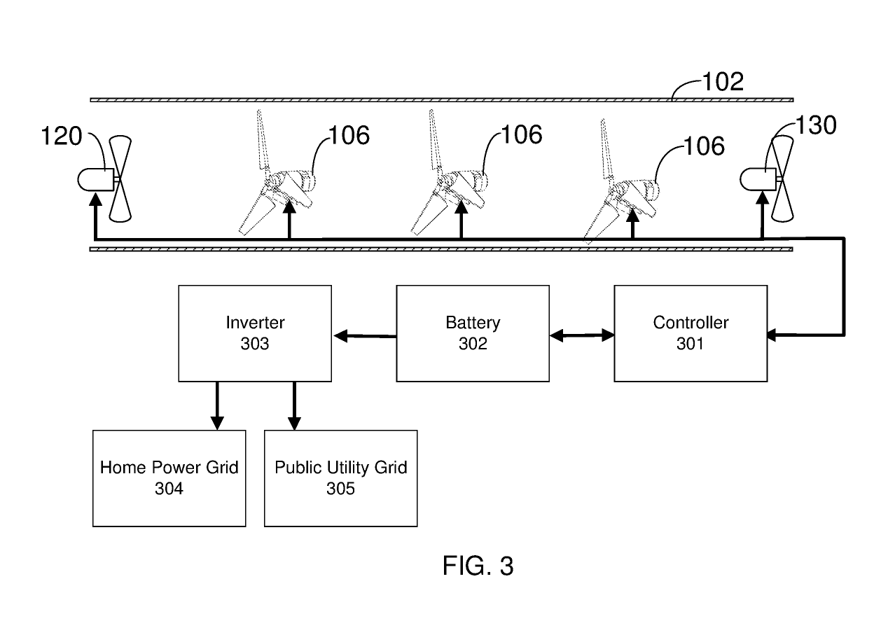

In reference to FIG. 3, a controller can be located on the outside of the generator assembly. In some embodiments, the controller is specifically the electrical module that connects the plurality of turbines to a power storage device, and/or to the power grid of a household. Additionally, the controller allows a maintainer to calibrate the generator assembly. The controller 301 can include a switch, a voltage regulating device, and a charge controller. The switch of the controller is the toggle switch that turns on the plurality of fans. The switch is also programmable to change the parameters of the plurality of fans for optimization of the generator assembly. The voltage regulating device and the charge controller convert the electricity generated by the wind turbine into a DC voltage suitable for battery charging and then passes the voltage to a battery bank for storing power. Electricity from the battery bank 302 passes through inverter 303, which converts the DC power from the batteries into AC power for use locally (such as by a home electrical grid 304) or for transfer to a public utility grid 305. In some embodiments, the battery bank 302 is main power source of the plurality of fans and the controller of the generator assembly. Some embodiments can also include a meter (such as a typical power meter) to track how much energy is used locally or transferred to a public utility grid. The meter thus provides feedback that can be used to further calibrate and optimize the generator assembly.

Embodiments of the present invention can have a much smaller “footprint” than many modern conventional wind turbines. For reasons of efficiency and scale, many conventional wind turbines are over 100 feet in width and must be mounted up to 200 feet in the air to take advantage of a high enough wind velocity for effective operation. In contrast, embodiments of the invention can be much smaller. Some embodiments, for example, could be as small as 5 to 10 feet in length and 3 to 5 feet in height. This allows such embodiments to be effectively used in many locations that are not practical for existing conventional wind turbines.

Embodiments of the invention can be used in virtually any location where there is a steady ambient airflow with a prevailing wind direction. For example, the tops and sides of commercial and residential buildings tend to be some of the windiest locations in the world since wind must flow around and over these structures rather than passing through them. This tends to concentrate air flows in predictable patterns. Some embodiments of the invention are suitable for mounting on the rooftops or sides of such buildings and aligned with the prevailing wind flows around and/or over the buildings.

Some embodiments are also suitable for mounting, for example, on the rooftops or sides of single-family homes. Because the rotating blades in the assembly are contained within an enclosure, there is no danger to wildlife or home owners. Embodiments with a relatively small number of wind turbines, for example only one or two such wind turbines, would be suitable for delivering most or even all of the generated power directly into the home itself for use with no grid interconnect necessary.

Some embodiments are especially suited for locations where the ambient airflow is primarily in one known direction so that the genitor assembly can be mounted with its longitudinal axis is in alignment with the wind direction. For example, embodiments could also be mounted onto a moving vehicle such as a truck or train or in a tunnel or elevator shaft.

Some embodiments of the invention are intended to be mounted so that the axis of the airflow pathway is permanently aligned with the prevailing wind direction. Ambient air flow that is not directly aligned with the air flow pathway can be redirected and channeled by the use of the induction fan so that such embodiments can make use of wind flows that are not in alignment with the airflow pathway of the generator assemble. In some embodiments, permanently aligned generator assemblies can be reversed to take advantage od wind flows in the opposite direction. The direction of rotation of the induction and vacuum fans can be reversed to cause air to flow through the assembly and past the wind turbines in the opposite direction. Reversing the operation of the assembly can be effected manually or can occur automatically using a wind direction sensor and a control system to effect the reversal of fan rotation. Other embodiments of the invention can be mounted so that the alignment of the air flow pathway can be adjusted, either manually or automatically, to better align the airflow pathway with the prevailing wind direction.

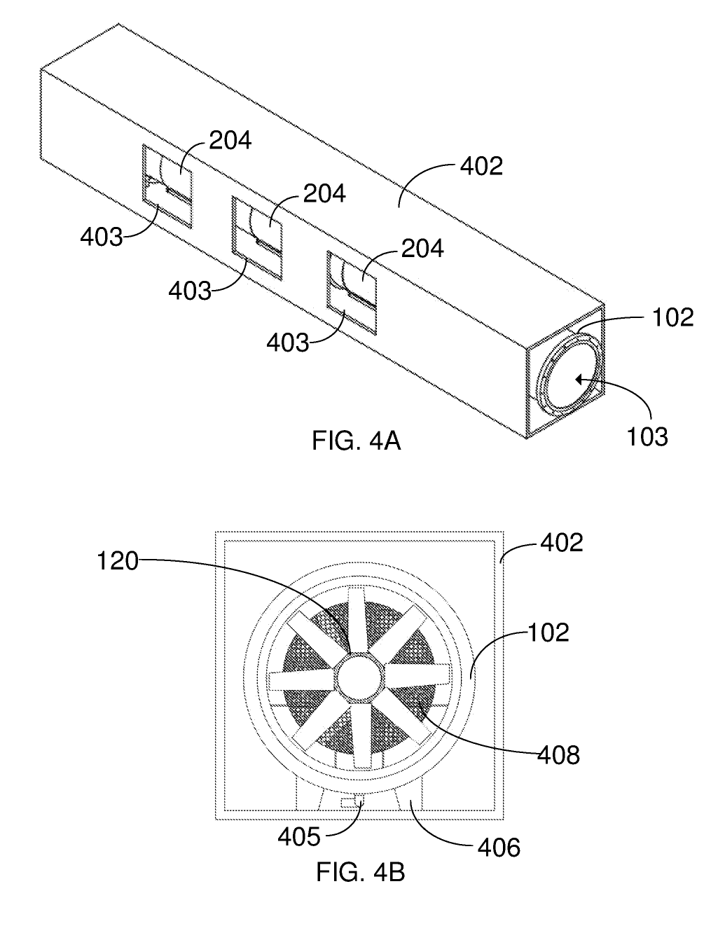

In some embodiments, a wind turbine generator assembly, for example the one shown in FIG. 1A, could be enclosed within an outer housing to provide physical protection for the other components and for ease of mounting or installation. FIG. 4 shows an example of an outer housing containing the wind generator assembly of FIG. 1A. In some embodiments, the housing is a weatherproof box-like housing that stabilizes, secures, and protects one or more enclosures/air pathways and the components that reside in the enclosure(s). By way of a non-limiting example, an outer housing could be made of metal or another durable material and could have a square or rectangular cross section to make it easier to mount on flat surfaces or to stack multiple assemblies together. Access doors 403 located on the sides of the housing can be used to access the turbines and/or electrical connections through corresponding access ports 205 in the enclosure. In some embodiments, access doors 204 in the enclosure itself will create an air tight seal and have a smooth interior surface so as not to interfere with air flow through the enclosure. In some embodiments a screen 408 can be attached within the air flow pathway to prevent foreign material from reaching and possibly damaging the wind turbines.

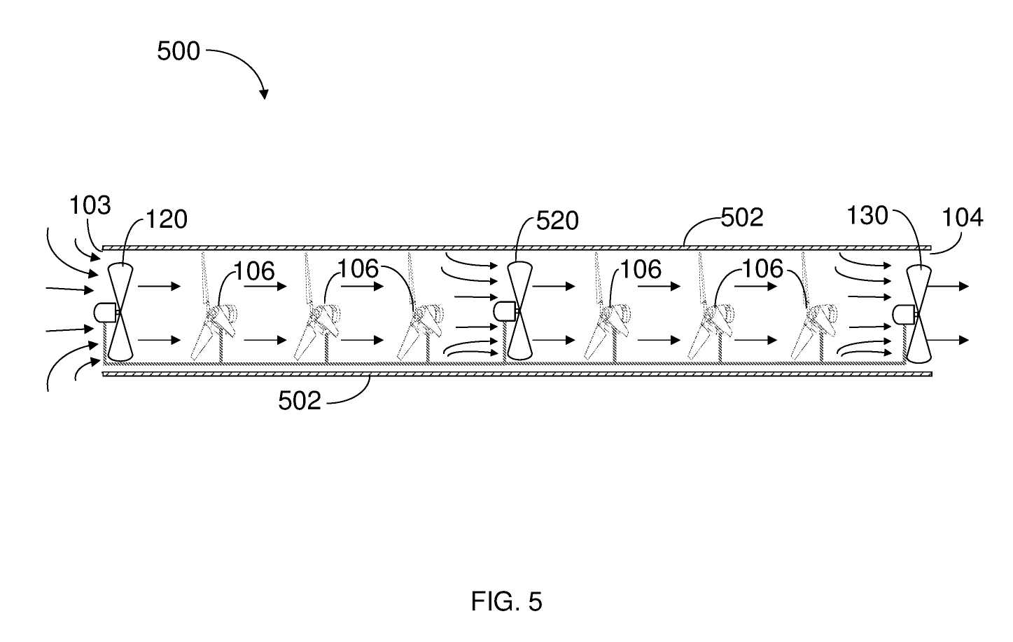

As described above, although the embodiment of FIG. 1A uses three turbines, different numbers and sizes of turbines can be used depending upon factors such as power generation requirements and environmental conditions. Where a large number of co-axial wind turbines are use, additional powered fans can be used, with some turbines located upstream from each additional powered fan and some located downstream. Such an embodiment is illustrated in FIG. 5. In this configuration, each additional powered fan 520 will function as a vacuum fan with respect to upstream wind turbines and as an induction fan with respect to downstream wind turbines.

In some embodiments, the generator assembly can be linked and wired with a plurality of generators, to form a power generation module. For example, in some embodiments, multiple “units,” each including an enclosure, at least one powered fan, and a desired number of wind turbines, could be connected together to form a larger assembly, with the total length dependent only on space considerations and power requirements. In other embodiments, multiple units could be stacked vertically and/or horizontally.

The use of multiple linked generator units could be especially useful in areas with lower average wind speed. It is generally acknowledged that a wind speed of five meters per second or about eleven miles per hour is required in order to make energy recovery economically feasible using conventional wind turbine systems. Embodiments of the present invention can show a net energy production at lower wind speed due to the acceleration provided by the powered fans, but the net energy production is obviously smaller where there is less energy available from ambient air flow. Using a number of linked generator units according to embodiments of the invention would allow the production of any desired amount of energy even where there is less than the minimum wind speeds required by conventional wind turbines.

The invention described herein has broad applicability and can provide many benefits as described and shown in the examples above. The embodiments will vary greatly depending upon the specific application, and not every embodiment will provide all the benefits and meet all the objectives that are achievable by the invention. While the invention is described above with reference to air/wind as the medium, it will be appreciated that the invention with modifications, which are well-known and obvious, can be applicable to other fluids such as water.

Whenever the terms “automatic,” “automated,” or similar terms are used herein, those terms will be understood to include manual initiation of the automatic or automated process or step. In the discussion and in the claims, the terms “including” and “comprising” are used in an open-ended fashion, and thus should be interpreted to mean “including, but not limited to . . . .” To the extent that any term is not specially defined in this specification, the intent is that the term is to be given its plain and ordinary meaning. The accompanying drawings are intended to aid in understanding the present invention and, unless otherwise indicated, are not drawn to scale. As used herein, the words “right,” “left,” “lower,” “upper,” “bottom,” “horizontal,” “vertical,” and the like designate directions in the drawings to which reference is made. These terms are used for convenience only and are not limiting.

Further, it should be recognized that embodiments of the present invention can be implemented via computer hardware or software, or a combination of both. The methods can be implemented in computer programs using standard programming techniques—including a computer-readable storage medium configured with a computer program, where the storage medium so configured causes a computer to operate in a specific and predefined manner—according to the methods and figures described in this Specification. Each program may be implemented in a high level procedural or object-oriented programming language to communicate with a computer system. However, the programs can be implemented in assembly or machine language, if desired. In any case, the language can be a compiled or interpreted language. Moreover, the program can run on dedicated integrated circuits programmed for that purpose.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The figures described herein are generally schematic and do not necessarily portray the embodiments of the invention in proper proportion or scale.

1-34. (canceled)

35. A wind turbine generator apparatus comprising:
an enclosure forming an air pathway for at least a portion of a moving air stream, said enclosure having an inlet opening at the upstream end of said enclosure and an outlet opening at the downstream end of said enclosure;
a powered induction fan located at the upstream end of the enclosure air pathway for directing and accelerating at least a portion of a moving air stream into the inlet opening of the enclosure and along the air pathway;
a powered vacuum fan located at the downstream end of the enclosure air pathway, the vacuum fan operating to create a negative pressure downstream from the wind turbine to increase air flow across the wind turbine and increase the efficiency of power generation by the wind turbine; and
one or more wind turbines mounted within the enclosure air pathway in between the induction fan and the vacuum fan, said one or more wind turbines generating power from the air stream flow through the air pathway.

36. The apparatus of claim 35 in which the air pathway within the enclosure forms a straight path with no turns and has a substantially constant cross-section between the location of the induction fan and the vacuum fan.

37. The apparatus of claim 36 in which the enclosure comprises a hollow enclosure with an inlet opening and an outlet opening in fluid communication so that an air stream entering the enclosure through the inlet opening will flow through the enclosure to the outlet opening.

38. The apparatus of claim 35 in which the powered induction fan operates to direct ambient atmospheric air flow along the air pathway causing the one or more wind turbines to convert a portion of the energy in the air flow to mechanical or electrical energy.

39. The apparatus of claim 35 in which the induction fan is mounted in or near the inlet opening of the enclosure so that during operation the induction fan pulls ambient air into the air pathway formed by the enclosure and accelerates the air flow down the air pathway toward the one or more wind turbines.

40. The apparatus of claim 35 in which the induction fan is mounted so that its horizontal axis of rotation is coaxial with the longitudinal axis of the air flow path longitudinal axis of the air flow path.

41. The apparatus of claim 35 in which the induction fan is driven by a variable-speed electric motor so that the speed of the induction fan can be varied in response to changes in the velocity of the ambient air flow so as to provide a constant air velocity across the one or more wind turbines.

42. The apparatus of claim 35 in which the induction fan operates to collect and direct ambient air flow from an area much larger than the inlet opening.

43. The apparatus of claim 35 in which the induction fan operates to collect and re-direct ambient air flow that is not directly aligned with the airflow pathway.

44. The apparatus of claim 35 in which the induction fan operates to concentrate and accelerate a larger amount of flowing air through the enclosure than would otherwise be produced by ambient air flow alone.

45. The apparatus of claim 44 in which the powered vacuum fan operates to produce a negative pressure area in the portion of the air pathway downstream from the one or more wind turbines, which draws more air through the turbines, and which, in turn, increases the efficiency of energy capture by the turbines.

46. The apparatus of claim 45 in which the efficiency of at least one of the one or more wind turbines during operation of the apparatus exceeds the maximum wind turbine efficiency calculated using the “Betz” momentum theory.

47. The apparatus of claim 35 in which the powered vacuum fan operates to pull away air that has passed downstream from a wind turbine.

48. The apparatus of claim 35 in which the powered vacuum fan operates to create a negative pressure in the air pathway downstream from the wind turbine to decrease backpressure and increase the wind turbine efficiency.

49. The apparatus of claim 35 in which the powered vacuum fan is mounted in or near the outlet opening of the enclosure to draw air out of the air pathway where it will be discharged to atmosphere.

50. The apparatus of claim 35 in which the powered vacuum fan is mounted so that its horizontal axis of rotation is coaxial with the longitudinal axis of the air flow path longitudinal axis of the air flow path.

51. The apparatus of claim 35 in which the powered vacuum fan operates to pull and accelerate the lower energy air flow that has already passed downstream from the one or more wind turbines and cause this air flow to be discharged through the outlet opening.

52. The apparatus of claim 35 in which the one or more wind turbines comprises a plurality of wind turbines and further comprising an additional powered fan mounted in the air pathway downstream from at least one wind turbine and upstream from at least one wind turbine, the additional powered fan operating as a vacuum fan with respect to the upstream wind turbine and as an induction fan with respect to the downstream wind turbine.

53. The apparatus of claim 35 in which two wind turbine generator apparatuses as described in claim 1 are connected together in series so that air flow exiting the outlet opening of a first enclosure flows into the inlet opening of a second enclosure.

54. The apparatus of claim 35 in which a plurality of wind turbine generator apparatuses as described in claim 1 are connected together electrically to form an array of wind turbine generators to increase the total power output for a given ambient wind speed.
